(19) United States
(12) Patent Application Publication
(10) Pub. No.: US 2019/0056686 A1
(43) Pub. Date: Feb. 21, 2019

(54) FIXATION APPARATUS AND IMAGE FORMATION APPARATUS

(71) Applicant: KONICA MINOLTA, INC., Tokyo (JP)

(72) Inventor: Masataka YAGI, Okazaki-shi (JP)

(73) Assignee: KONICA MINOLTA, INC., Tokyo (JP)

(21) Appl. No.: 16/102,829

(22) Filed: Aug. 14, 2018

(30) Foreign Application Priority Data
Aug. 18, 2017 (JP) 2017-158056
Mar. 30, 2018 (JP) 2018-068381

(51) Int. Cl. G03G 15/20

(52) U.S. Cl. CPC G03G 15/2057; G03G 2215/2025

(57) ABSTRACT

A fixation apparatus includes an endless fixation belt, a heat source which heats the fixation belt, a pad member arranged on an inner circumferential side of the fixation belt, a rotational pressurization member which presses the pad member with the fixation belt being interposed, and a soaking member provided between the pad member and the fixation belt. A thermal conductivity λ of the soaking member satisfies relation of λ≥500 [W/(m·K)].

The entire disclosure of Japanese Patent Applications Nos. 2017-158056 and 2018-068381 filed on Aug. 18, 2017 and Mar. 30, 2018, respectively, is incorporated herein by reference in its entirety.

### BACKGROUND

### Technological Field

The present invention relates to a fixation apparatus and an image formation apparatus.

### Description of the Related Art

In connection with a conventional fixation apparatus, for example, Japanese Laid-Open Patent Publication No. 2009-251253 discloses a fixation apparatus which can achieve reduced warming-up time and is excellent in slidability.

The fixation apparatus disclosed in Japanese Laid-Open Patent Publication No. 2009-251253 includes a fixation belt. The fixation belt includes a base layer formed from a cylindrically formed metal layer (for example, SUS or Ni), an elastic layer (silicone rubber) formed around an outer circumferential surface of the base layer, and a release layer (a fluorine-based resin such as PTFE) formed around an outer circumferential surface of the elastic layer.

In the fixation apparatus, a thermal capacity of the fixation belt is minimized by decreasing a thickness of the fixation belt. Furthermore, a surface layer composed of at least one of carbon, diamond-like carbon, and molybdenum disulfide is formed on an inner circumferential surface of the fixation belt (an inner circumferential surface of the base layer).

In addition, Japanese Laid-Open Patent Publication No. 2013-68724 discloses a conventional fixation apparatus.

### SUMMARY

As disclosed in Japanese Laid-Open Patent Publication No. 2009-251253, a fixation apparatus which fixes a toner image onto a recording medium such as paper by heating and pressurizing the recording medium by using the fixation belt has been known. In successive feed of sheets of paper of a small size such as A6 or A5 to the fixation apparatus, heat transfer from the fixation belt to the paper does not progress in a non-paper-feed (and heated) region in the fixation belt, and hence such a phenomenon as local increase in temperature of the fixation belt may occur.

For a fixation apparatus, there are a heating roller system in which heat generated from a heat source is transferred to a fixation belt through a heating roller and a direct heating (heating-roller-less) system in which heat generated from a heat source is directly transferred to a fixation belt. In the fixation apparatus adapted to the heating roller type, the heating roller itself has a function to soak the fixation belt. The fixation apparatus adapted to the direct heating type does not include a heating roller, and hence such a phenomenon as local increase in temperature of the fixation belt may noticeably occur.

An object of the present invention is to provide a fixation apparatus and an image formation apparatus in which local increase in temperature of a fixation belt is suppressed.

To achieve at least one of the abovementioned objects, according to an aspect of the present invention, a fixation apparatus reflecting one aspect of the present invention comprises an endless fixation belt, a heat source which heats the fixation belt, a pad member arranged on an inner circumferential side of the fixation belt, a rotational pressurization member which presses the pad member with the fixation belt being interposed, and a soaking member provided between the pad member and the fixation belt. A thermal conductivity λ of the soaking member satisfies relation of λ≥500 [W/(m·K)].

To achieve at least one of the abovementioned objects, according to an aspect of the present invention, an image formation apparatus reflecting one aspect of the present invention comprises a transport portion which transports a recording medium and the fixation apparatus described above, the fixation apparatus fixing a toner image to the recording medium.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram schematically showing an overall construction of an image formation apparatus according to a first embodiment.

FIG. 2 shows a fixation apparatus according to the first embodiment.

FIG. 3 is a partially enlarged view of the fixation apparatus shown in FIG. 2.

FIG. 4 is a partial schematic diagram of the fixation apparatus shown in FIG. 2.

FIG. 5 shows a table showing values of physical properties of various materials.

FIG. 6 shows a graph of relation between a thickness t of a soaking member and a thermal conductivity λ.

FIG. 7 is a schematic diagram of a graphite sheet and a PTFE coating when the PTFE coating is fired.

FIG. 8 is a schematic diagram of the graphite sheet and the PTFE coating when the PTFE coating is fired and thereafter returns to a room temperature.

FIG. 9 is a diagram showing a state that the curved graphite sheet and PTFE coating shown in FIG. 8 are smoothed out and attached to a pad member.

FIG. 10 is a diagram showing a solid lubrication layer in a simplified manner.

FIG. 11 is a schematic diagram of the solid lubrication layer according to a second embodiment.

FIG. 12 is a schematic diagram of the soaking member according to a third embodiment.

FIG. 13 shows a graph showing test results in Example 1.

FIG. 14 shows a graph showing test results in Example 2.

FIG. 15 shows a table showing test results in Example 3.

FIG. 16 shows a photograph of a solid lubrication layer of which test results are evaluated as “D”.

FIG. 17 is a schematic diagram of a stack-type graphite sheet when the PTFE layer is fired.

FIG. 18 is a schematic diagram of the stack-type graphite sheet when the PTFE layer is fired and thereafter returns to a room temperature.

FIG. 19 shows a table showing test results in Example 4.

FIG. 20 shows a photograph of a stack-type graphite sheet of which evaluation results are indicated as “C”.

FIG. 21 is a side view showing a fixation apparatus in a fourth embodiment.

FIG. 22 is a diagram schematically showing relation between a long heater in FIG. 21 and a size of paper.

FIG. 23 is a diagram schematically showing relation between a short heater in FIG. 21 and a size of paper.

FIG. 24 is a side view showing the fixation apparatus in an area surrounded by a chain double dotted line XXIV in FIG. 21.

FIG. 25 is a perspective view partially showing the pad member in FIG. 24.

FIG. 26 is a cross-sectional view showing a surface layer of the pad member in FIG. 24 as being enlarged.

FIG. 27 shows a graph of thermal conductivities of graphite sheets and various materials.

FIG. 28 shows a table of comparison of a total thickness and a heat transfer property of soaking members, between a soaking member formed of a stack of graphite sheets and a soaking member formed of a single-layered graphite sheet.

FIG. 29 shows a table showing an effect of lowering in temperature of the fixation belt when a soaking member is formed of a stack of a plurality of graphite sheets in Example 5.

FIG. 30 is a diagram showing a manner in a graphite sheet winding test in Example 6.

FIG. 31 shows a table showing results in the winding test in FIG. 30.

### DETAILED DESCRIPTION OF EMBODIMENTS

Hereinafter, one or more embodiments of the present invention will be described with reference to the drawings. However, the scope of the invention is not limited to the disclosed embodiments. The same or substantially the same features in embodiments below have the same reference characters allotted and redundant description will not be repeated. Features in the embodiments described below may selectively be combined as appropriate.

### First Embodiment

<Image Formation Apparatus 1>

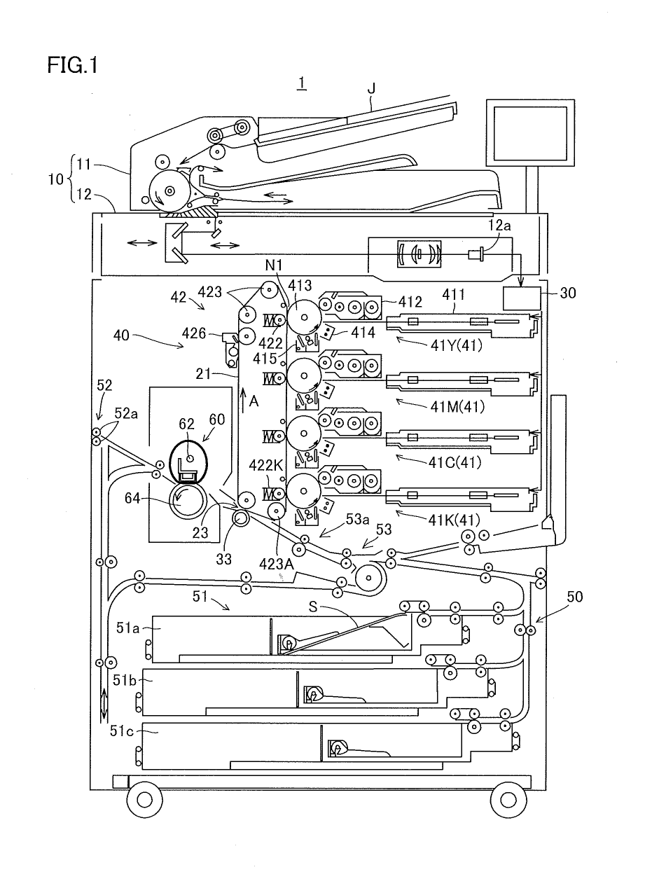

FIG. 1 is a diagram schematically showing an overall construction of an image four ation apparatus 1 according to a first embodiment. Image formation apparatus 1 is a color image formation apparatus of an intermediate transfer type which makes use of an electrophotography process technique. Image formation apparatus 1 primarily transfers a toner image of each color of yellow (Y), magenta (M), cyan (C), and black (K) formed on a photoconductor drum 413 to an intermediate transfer belt 21. Image formation apparatus 1 forms an image by layering toner images of four colors on intermediate transfer belt 21 and thereafter secondarily transferring the toner images to a transported recording medium. For example, plain paper is adopted as a recording medium.

A tandem system is adopted for image formation apparatus 1. According to the tandem system, photoconductor drums 413 corresponding to four colors of YMCK are arranged along a direction in which intermediate transfer belt 21 runs (shown with an arrow A in FIG. 1). According to the tandem system, toner images of four colors of YMCK are transferred successively onto intermediate transfer belt 21 in one procedure.

Image formation apparatus 1 includes an image reading portion 10, an image processing portion 30, an image formation portion 40, a transport portion 50, and a fixation apparatus 60.

(Image Reading Portion 10)

Image reading portion 10 includes an automatic document feed apparatus 11 referred to as an auto document feeder (ADF) and a document image scanning apparatus 12 (a scanner). Automatic document feed apparatus 11 transports a document J placed on a document tray with a transport mechanism and feeds the document to document image scanning apparatus 12. Automatic document feed apparatus 11 allows successive reading at once of images (on opposing surfaces) of a number of documents J placed on the document tray.

Document image scanning apparatus 12 optically scans a document transported from automatic document feed apparatus 11 to contact glass or a document placed on the contact glass. Document image scanning apparatus 12 forms an image of reflected light from the document on a light receiving surface of a charge coupled device (CCD) sensor 12a and reads a document image. Image reading portion 10 generates input image data based on a result of reading by document image scanning apparatus 12. The input image data is subjected to prescribed image processing in image processing portion 30.

(Image Processing Portion 30)

Image processing portion 30 includes a circuit which subjects the input image data generated by image reading portion 10 to digital image processing in accordance with initial setting or user setting. For example, image processing portion 30 corrects gray levels based on gray level correction data (gray level correction table).

Image processing portion 30 subjects the input image data not only to gray level correction but also to various types of correction processing such as color correction and shading correction and compression processing. Image formation portion 40 is controlled based on the image data subjected to such processing.

(Image Formation Portion 40)

Image formation portion 40 includes image formation units 41Y, 41M, 41C, and 41K and an intermediate transfer unit 42. Image formation units 41Y, 41M, 41C, and 41K and intermediate transfer unit 42 form images with toner of respective colors of a Y component, an M component, a C component, and a K component, based on the image data processed by image processing portion 30.

Image formation units 41Y, 41M, 41C, and 41K are similarly constructed. For the sake of convenience of illustration and description, common components have the same reference characters allotted, and a suffix Y, M, C, or K is added to a reference sign when distinction is made. In FIG. 1, reference signs are given only to components in image formation unit 41Y for the Y component, and no reference sign is shown for components in other image formation units 41M, 41C, and 41K.

Image formation unit 41 includes an exposure apparatus 411, a development apparatus 412, photoconductor drum 413, a charging apparatus 414, and a drum cleaning apparatus 415. Photoconductor drum 413 is a negatively charged organic photoconductor (OPC) including a conductive cylindrical body (an aluminum pipe) made of aluminum. Photoconductor drum 413 has a diameter, for example, of 80 [mm]. An undercoat layer (UCL), a charge generation layer (CGL), and a charge transport layer (CTL) are successively stacked on an outer circumferential surface of photoconductor drum 413. Photoconductor drum 413 is rotated by a drive motor (which is not shown).

The charge generation layer is composed of an organic semiconductor in which a charge generation material (for example, a phthalocyanine pigment) is dispersed in a resin binder (for example, polycarbonate). The charge generation layer is exposed to light from exposure apparatus 411 and generates a pair of positive charge and a negative charge.

The charge transport layer is composed of a material in which a hole transport material (an electron-donating and nitrogen-containing compound) is dispersed in a resin binder (for example, polycarbonate). The charge transport layer transports positive charges generated in the charge generation layer to a surface of the charge transport layer.

Charging apparatus 414 evenly charges the surface of photoconductive photoconductor drum 413 to a negative polarity. Exposure apparatus 411 is implemented, for example, by semiconductor laser. Exposure apparatus 411 emits laser beams corresponding to an image of each color component to photoconductor drum 413.

As the positive charges are generated in the charge generation layer of photoconductor drum 413 and transported to the surface of the charge transport layer, surface charges (negative charges) of photoconductor drum 413 are neutralized. An electrostatic latent image of each color component is formed on the surface of photoconductor drum 413 owing to a potential difference from a portion around the same.

Development apparatus 412 is of a two-component development type. Development apparatus 412 forms a toner image by visualizing the electrostatic latent image by attaching toner of each color component to the surface of photoconductor drum 413.

Drum cleaning apparatus 415 includes a drum cleaning blade which is brought in sliding contact with the surface of photoconductor drum 413. Drum cleaning apparatus 415 removes toner which remains on the surface of photoconductor drum 413 after primary transfer.

Intermediate transfer unit 42 includes intermediate transfer belt 21, a primary transfer roller 422, a plurality of support rollers 423, a secondary transfer portion 23, and a belt cleaning apparatus 426. Intermediate transfer belt 21 is endless. Intermediate transfer belt 21 is looped around the plurality of support rollers 423. At least one of the plurality of support rollers 423 is implemented by a drive roller and others are implemented by driven rollers.

For example, a roller 423A arranged downstream from a primary transfer roller 422K for the K component in a direction of running of intermediate transfer belt 21 is preferably implemented by a drive roller. A speed of running of intermediate transfer belt 21 is thus readily held at a constant speed. As roller 423A rotates, intermediate transfer belt 21 runs at a constant speed in the direction shown with arrow A.

Intermediate transfer belt 21 is conducive and elastic. Intermediate transfer belt 21 includes a high-resistance layer of which volume resistivity is, for example, from 8 to 11 [logΩ·cm] on its surface. A material, a thickness, and a hardness of intermediate transfer belt 21 are not limited so long as the intermediate transfer belt is conductive and elastic.

Primary transfer roller 422 is arranged on an inner circumferential surface side of intermediate transfer belt 21. Primary transfer roller 422 is arranged as being opposed to photoconductor drum 413. Primary transfer roller 422 is brought in press contact with photoconductor drum 413 with intermediate transfer belt 21 being interposed. A primary transfer nip portion N1 is thus formed.

When intermediate transfer belt 21 passes through primary transfer nip portion N1, toner images on photoconductor drums 413 are primarily transferred successively onto intermediate transfer belt 21 as being layered. Specifically, a primary transfer bias is applied to primary transfer roller 422, and charges opposite in polarity to toner are applied to a rear surface side (a side abutting on primary transfer roller 422) of intermediate transfer belt 21. The toner image is thus electrostatically transferred to intermediate transfer belt 21.

The toner image electrostatically transferred to intermediate transfer belt 21 is thereafter transported to secondary transfer portion 23. When a recording medium passes through secondary transfer portion 23, the toner image on intermediate transfer belt 21 is secondarily transferred to the recording medium. Specifically, a secondary transfer bias is applied to a secondary transfer roller 33, and charges opposite in polarity to toner are applied to a side of the recording medium which abuts on secondary transfer roller 33. The toner image is thus electrostatically transferred to the recording medium.

Belt cleaning apparatus 426 comes in contact with an outer circumferential surface of intermediate transfer belt 21. Belt cleaning apparatus 426 removes toner which remains on the surface of intermediate transfer belt 21 after secondary transfer.

The recording medium to which the toner image has been transferred passes through secondary transfer portion 23, and thereafter transported to fixation apparatus 60. Fixation apparatus 60 fixes the toner image onto the recording medium to which the toner image has secondarily been transferred by heating and pressurizing the recording medium. Details of fixation apparatus 60 will be described later.

(Transport Portion 50)

Transport portion 50 transports a recording medium. Transport portion 50 includes a paper feed portion 51, a paper ejection portion 52, and a transport path portion 53. Paper feed portion 51 includes paper feed tray units 51a, 51b, and 51c. Paper S (standard paper and special paper) identified based on a basis weight or a size is accommodated in paper feed tray units 51a, 51b, and 51c for each type set in advance.

Paper S accommodated in paper feed tray units 51a, 51b, and 51c is sent from an uppermost portion one by one and transported to transport path portion 53. Transport path portion 53 includes a plurality of pairs of transport rollers including a registration roller pair 53a. A registration roller portion in which registration roller pair 53a is disposed rectifies tilt and unbalanced arrangement of a recording medium. The recording medium is transported to secondary transfer portion 23 through transport path portion 53. Toner images on intermediate transfer belt 21 are collectively secondarily transferred to one surface of paper S in secondary transfer portion 23 and thereafter subjected to a fixation process in fixation apparatus 60.

The recording medium which has passed through fixation apparatus 60 is transported to paper ejection portion 52. Paper ejection portion 52 includes a transport roller pair (paper ejection roller pair) 52a. The recording medium on which the image is formed is ejected to the outside through transport roller pair 52a.

(Fixation Apparatus 60)

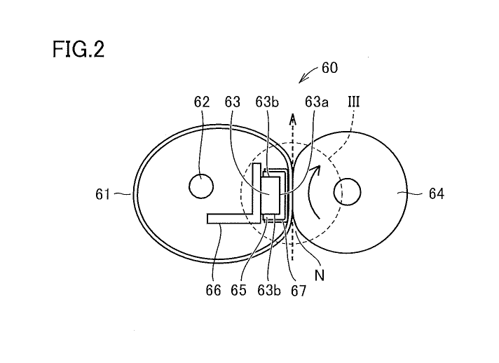

FIG. 2 shows fixation apparatus 60 according to the first embodiment. Fixation apparatus 60 includes an endless fixation belt 61, a heat source 62, a pad member 63, a rotational pressurization member 64, and a support member 66. Fixation apparatus 60 according to the first embodiment is adapted to the direct heating (heating-roller-less) system in which heat generated from heat source 62 is directly transferred to fixation belt 61.

Heat source 62 is implemented, for example, by a halogen heater. Heat source 62 is arranged on the inner circumferential side of fixation belt 61. Heat source 62 heats fixation belt 61 from the inner side by emitting light. Fixation belt 61 is not suspended.

Rotational pressurization member 64 is implemented, for example, by a pressurization roller. Rotational pressurization member 64 includes an elastic layer composed of silicone rubber on an outer circumferential surface thereof. Rotational pressurization member 64 comes in contact with the outer circumferential surface of fixation belt 61. Rotational pressurization member 64 is arranged as being opposed to pad member 63. As rotational pressurization member 64 presses pad member 63 with fixation belt 61 being interposed, a fixation nip portion N is formed. Rotational pressurization member 64 is driven to rotate by a not-shown drive source. Rotational pressurization member 64 rotates fixation belt 61 such that fixation belt 61 follows rotation thereof and transports a recording medium.

Support member 66 is arranged on the inner circumferential side of fixation belt 61. Support member 66 is coupled to pad member 63. Support member 66 fixes pad member 63. Pad member 63 is arranged on the inner circumferential side of fixation belt 61. Pad member 63 is in a shape of a rectangular bar which extends in an axial direction of rotational pressurization member 64. Pad member 63 includes an opposing surface 63a which is opposed to rotational pressurization member 64 and a pair of side surface portions 63b. Side surface portion 63b is provided substantially at a right angle to opposing surface 63a. A shape of fixation nip portion N is determined by a shape of pad member 63.

Fixation belt 61 heated by heat source 62 heats and pressurizes a recording medium while it transports the recording medium in cooperation with rotational pressurization member 64. Fixation apparatus 60 thus fixes a toner image on the recording medium onto the recording medium.

(Soaking Member 65)

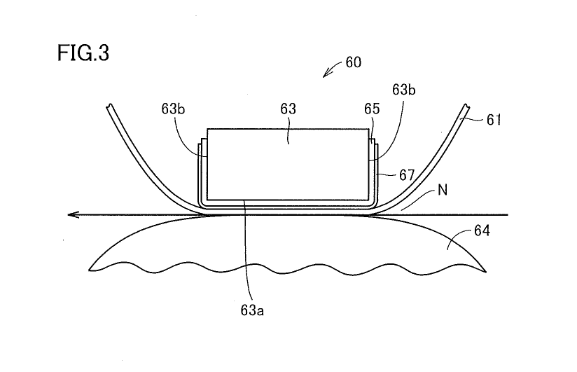

FIG. 3 is a partially enlarged view of fixation apparatus 60 shown in FIG. 2. FIG. 3 shows as being enlarged, a part of fixation apparatus 60 which corresponds to a region III shown in FIG. 2. Fixation apparatus 60 further includes a soaking member 65 and a solid lubrication layer 67.

Soaking member 65 in a form of a layer is provided to cover opposing surface 63a and side surface portions 63b. Soaking member 65 is provided between pad member 63 and fixation belt 61. Soaking member 65 is in contact with pad member 63. Soaking member 65 extends in the axial direction of rotational pressurization member 64 similarly to pad member 63. Soaking member 65 has a high heat transfer function (a soaking function) in the axial direction of rotational pressurization member 64. The soaking function will be described in detail below.

(Soaking Function)

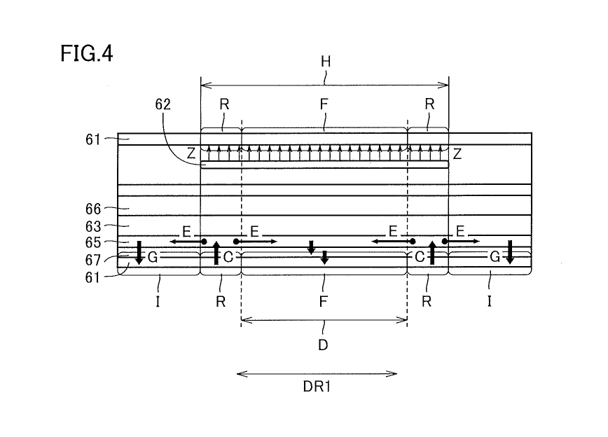

FIG. 4 is a partial schematic diagram of fixation apparatus 60 shown in FIG. 2. FIG. 4 schematically shows a portion on the inner circumferential side of fixation belt 61 shown in FIG. 2 when viewed in an axial direction DR1 of rotational pressurization member 64.

Heat source 62 extends in axial direction DR1. Heat source 62 heats fixation belt 61 from the inner circumferential side (an arrow Z in FIG. 4) over a length H (which is denoted as heat source length H below) in axial direction DR1 of heat source 62.

A width of paper which passes through fixation nip portion N is denoted as D (which is denoted as a paper width D below). A dotted line shown in FIG. 4 represents a region where paper passes through fixation nip portion N (which is denoted as a paper feed region below). Heat from fixation belt 61 is transferred to paper in the paper feed region. Therefore, even when paper is successively fed, a temperature of fixation belt 61 (a region F in FIG. 4) in the paper feed region does not much increase.

When heat source length H is longer than paper width D, however, a region in fixation belt 61 which is heated over heat source length H (a heated region below) and is also a non-paper-feed region (an end region R below) is present. Even though a temperature of end region R significantly increases due to successive paper feed, heat thereof is not transferred to paper, and hence a temperature of end region R will greatly increase.

A problem due to increase in temperature in the end region is likely in printing on paper having a small paper width such as A5 or A6. When a temperature of a heat source (a heater) is set such that a temperature of the fixation belt in the paper feed region attains to 150 [° C.] and A5 plain paper (90 [g/m²]) is fed successively for several minutes at a rate of paper feed of 20 sheets per minute, a temperature in the end region exceeds 280 [° C.]. Since the fixation belt including an elastic layer made of silicone rubber is generally resistant to heat up to 230 [° C.], the fixation belt fails due to heat.

(Solution to Problem)

In order to address the problem of increase in temperature in the end region, soaking member 65 is provided between pad member 63 and fixation belt 61. Soaking member 65 has a thermal conductivity λ satisfying relation of λ≥500 [W/(m·K)]. As shown in FIG. 4, heat of end region R is transferred to soaking member 65 through solid lubrication layer 67 (an arrow C in FIG. 4). Thereafter, heat transferred from end region R to soaking member 65 is diffused to entire soaking member 65 in axial direction DR1 (an arrow E in FIG. 4). Since soaking member 65 is composed of a material having a high thermal conductivity which satisfies relation of λ≥500 [W/(m·K)], heat is rapidly diffused. Diffused heat is transferred to a low temperature portion I in fixation belt 61 (which is the non-paper-feed and non-heated region) through solid lubrication layer 67 (an arrow G in FIG. 4).

Heat from end region R is diffused to entire fixation belt 61, and a temperature of the entire region in fixation belt 61 becomes uniform. Soaking member 65 has such a soaking function.

In the conventional heating roller system in which heat generated from a heat source is transferred to a fixation belt through a heating roller, the heating roller extending in the axial direction has the soaking function. Since fixation apparatus 60 according to the first embodiment is adapted to the direct heating system, no heating roller is arranged therein and a soaking action by the heating roller is not expected. In fixation apparatus 60 according to the present first embodiment, soaking member 65 is provided between pad member 63 and fixation belt 61 so that soaking member 65 substitutes for the soaking function of the heating roller of the conventional fixation apparatus.

Copper or aluminum may be adopted for a member which brings about a soaking effect. Arrangement of a soaking member composed of copper or aluminum, however, leads to increase in thermal capacity in the fixation nip portion (=mass [kg]×specific heat [J/(kg·K)]). With increase in thermal capacity of the fixation nip portion, a longer time is required for temperature increase (a time period required until a temperature of the fixation belt in the paper feed region reaches a fixation temperature). With increase in time required for temperature increase, start of printing is delayed, and at the same time, energy efficiency also becomes poor. Therefore, a material which is high in thermal conductivity while it can keep a low thermal capacity is preferably selected as a material for the soaking member.

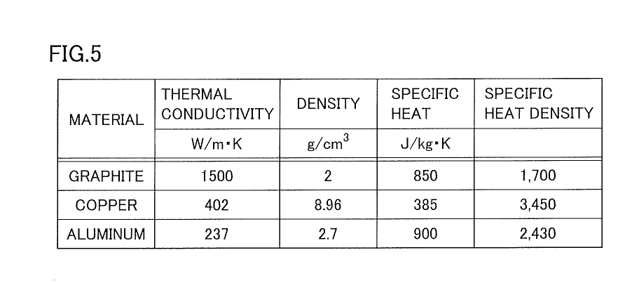

FIG. 5 shows a table showing values of physical properties of various materials. In selecting a soaking member low in thermal capacity, a density [g/cm³]×specific heat [J/(kg·K)] (=specific heat density) is desirably as low as possible. It can be seen in FIG. 5 that graphite is desirably used in order to keep a low thermal capacity while the soaking function is ensured (while the material remains high in thermal conductivity). By employing graphite as a material for the soaking member, time required for temperature increase can be suppressed while the soaking function is ensured.

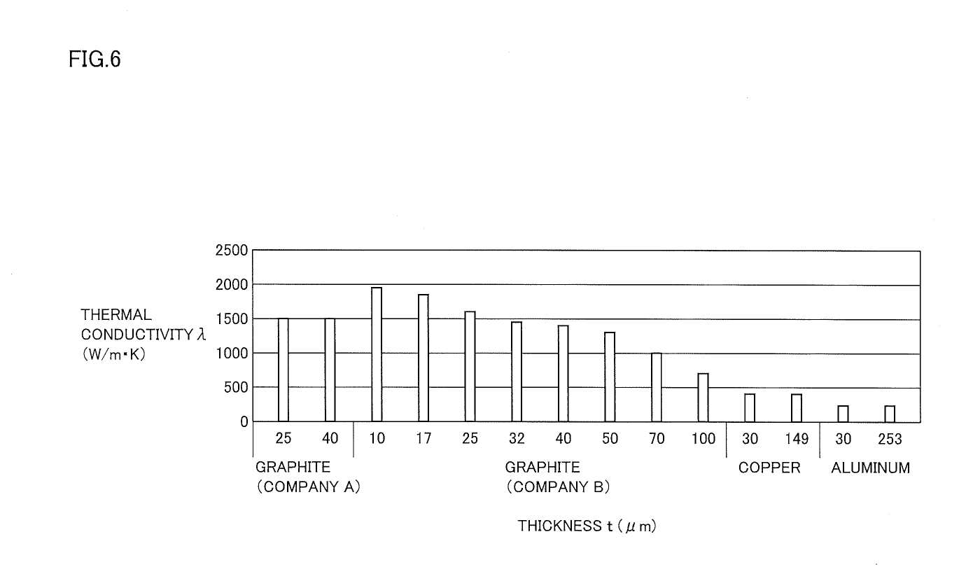

FIG. 6 shows a graph of relation between thickness t of the soaking member and thermal conductivity λ. A sheet composed of graphite (a graphite sheet below) has such a property that a thermal conductivity (a physical value) as a material is lower with increase in thickness thereof. Therefore, a graphite sheet having a thickness which allows an ensured appropriate thermal conductivity is preferably selected as soaking member 65.

When a graphite sheet having a thickness of 100 [μm] (having thermal conductivity λ=700 [W/(m·K)] and a dimension of a short side of 10 [mm]×a long side of 320 [mm]) shown in FIG. 6 is arranged over the entire region (320 [mm]) of pad member 63 in axial direction DR1 shown in FIG. 4, a highest temperature in end region R can be maintained at a temperature lower than 230 [° C.] (an upper limit temperature of the fixation belt).

(Solid Lubrication Layer 67)

Graphite itself is very brittle. When a graphite sheet directly abuts on the inner circumferential surface of the fixation belt, the graphite sheet is worn. Therefore, in order to improve a lubricating property of the graphite sheet, a sliding layer may be provided between the graphite sheet and the fixation belt. The sliding layer may contain a liquid lubricant such as lubricating oil or grease, or may include a solid lubrication layer (a coating layer composed of a solid lubricant). The coating layer composed of a solid lubricant includes also a coating layer composed of a binder resin containing a solid lubricant. Since friction force between the fixation belt and the graphite sheet is lowered by providing the sliding layer, drive torque of the fixation belt can be maintained low.

When the sliding layer provided between the graphite sheet and the fixation belt contains a liquid lubricant, a region where the sliding layer is provided becomes non-uniform and slidability between the graphite sheet and the fixation belt becomes unstable. Furthermore, when the liquid lubricant is contained, the liquid lubricant leaks to a portion around the fixation apparatus. Therefore, a mechanism for suppressing leakage of the liquid lubricant is additionally required. From a point of view of a compact fixation apparatus, a solid lubrication layer is preferably employed. Examples of a solid lubricant to be contained in the solid lubrication layer include molybdenum disulfide, a fluorine resin, and graphite.

When a solid lubrication layer is provided in the graphite sheet, too large a thickness of the solid lubrication layer (specifically, a thickness exceeding 100 [μm]) leads to difficulty in heat transfer from the fixation belt through the solid lubrication layer to the graphite sheet (soaking member). Since the soaking effect achieved by the graphite sheet is thus impaired in one aspect, a thickness of the solid lubrication layer is preferably minimized.

In order to realize a solid lubrication layer as small as possible in thickness, a method of forming a polytetrafluoroethylene (PTFE) coating on a graphite sheet is available. In order to form a PTFE coating, however, firing at a temperature as high as 380 [° C.] is required.

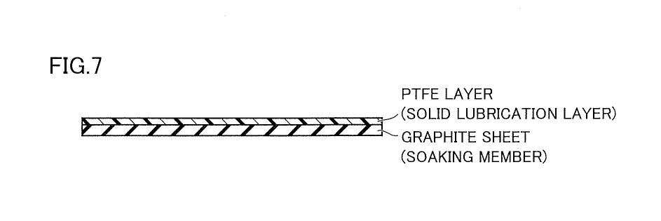

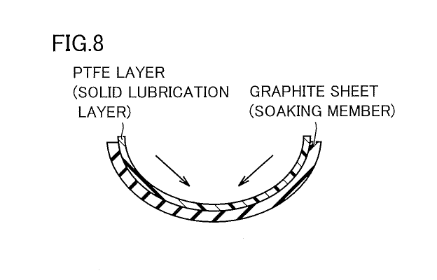

FIG. 7 is a schematic diagram of a graphite sheet and a PTFE coating when the PTFE coating is fired. FIG. 8 is a schematic diagram of the graphite sheet and the PTFE coating when the PTFE coating is fired and thereafter returns to a room temperature.

The solid lubrication layer (PTFE layer) shrinks more than the soaking member (graphite sheet) when a temperature returns to a room temperature after firing at 380 [° C], due to a difference in coefficient of linear thermal expansion between PTFE (=100×10⁻⁶[° C.⁻¹]) and graphite (=5×10⁻⁶ [° C.⁻¹]). Therefore, as shown in FIG. 8, the graphite sheet is curved as being located on an outer periphery of the PTFE layer.

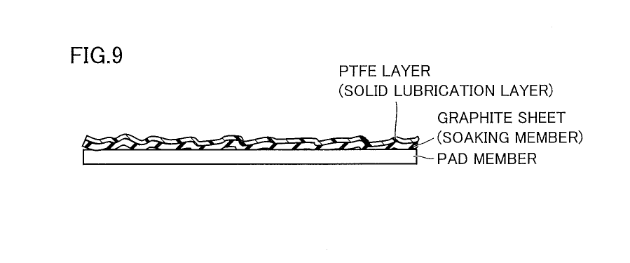

FIG. 9 is a diagram showing a state that the curved graphite sheet and PTFE coating shown in FIG. 8 are smoothed out and attached to a pad member. When an attempt to forcibly attach the graphite sheet and the PTFE coating to the pad member against curving is made, the graphite sheet is kinked and wrinkled. Since the fixation nip portion is thus in a non-uniform shape, a surface pressure in the fixation nip portion becomes non-uniform.

(Solution to Problem)

In order to solve the problem of curving of the graphite sheet in firing of the solid lubrication layer, the solid lubrication layer of which amount of linear thermal expansion is controlled with the use of a filler or a binder may be fired on the graphite sheet. An amount of linear thermal expansion of the solid lubrication layer is controlled by adopting a solid lubrication layer small in difference in coefficient of linear thermal expansion from the graphite sheet or a solid lubrication layer low in firing temperature.

The firing temperature refers to a temperature for firing a solid lubrication layer and it is determined by a solid lubricant used for the solid lubrication layer. When a binder resin is to be contained in the solid lubrication layer, a firing temperature is determined by a type of the binder resin to be contained in the solid lubrication layer.

As shown in FIG. 3, solid lubrication layer 67 as a layer is provided to cover soaking member 65. Solid lubrication layer 67 is provided between soaking member 65 and fixation belt 61. Solid lubrication layer 67 is in contact with soaking member 65 and fixation belt 61. Solid lubrication layer 67 slides against the inner circumferential surface of fixation belt 61.

A coefficient of friction of solid lubrication layer 67 against fixation belt 61 is smaller than a coefficient of friction of soaking member 65 against fixation belt 61. Friction force produced between solid lubrication layer 67 and fixation belt 61 is thus lowered. Therefore, durability of fixation belt 61 is improved. Furtheimore, drive torque of the fixation belt can be maintained low.

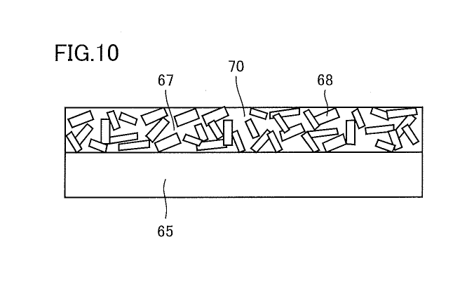

FIG. 10 is a diagram showing solid lubrication layer 67 in a simplified manner. Solid lubrication layer 67 contains a solid lubricant 68. The solid lubricant contains molybdenum disulfide. Solid lubrication layer 67 contains a polyamide-imide resin as a binder 70. Solid lubrication layer 67 has a coefficient of linear thermal expansion of 30×10⁻⁶ [° C.⁻¹]. A firing temperature of solid lubrication layer 67 is 180 [° C.].

By employing molybdenum disulfide as solid lubricant 68 and employing a polyamide-imide resin as the binder, a coefficient of linear thermal expansion of solid lubrication layer 67 can be greater. Therefore, a difference in coefficient of linear thermal expansion between the graphite sheet and solid lubrication layer 67 can be made smaller. Furthermore, a firing temperature of solid lubrication layer 67 can be lowered. An amount of linear thermal expansion of solid lubrication layer 67 can be controlled by selecting solid lubricant 68 and binder 70.

Even though solid lubrication layer 67 is fired on a graphite sheet having a thickness of 100 [μm], curved deformation of the graphite sheet (soaking member 65) and solid lubrication layer 67 can be suppressed because the firing temperature is low. Thus, no wrinkles are formed even after soaking member 65 and solid lubrication layer 67 are attached to the pad member and a shape of the fixation nip portion can be smooth. Therefore, good fixation quality can be ensured.

### Second Embodiment

FIG. 11 is a schematic diagram of solid lubrication layer 67 according to a second embodiment. Solid lubricant 68 further contains a fluorine resin or graphite powders. An amount of linear thermal expansion of solid lubrication layer 67 can thus be controlled. Therefore, curved deformation of soaking member 65 and solid lubrication layer 67 can be suppressed.

### Third Embodiment

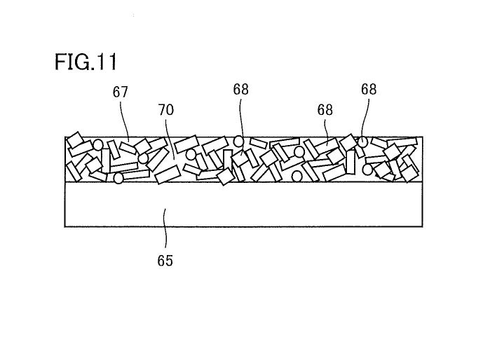

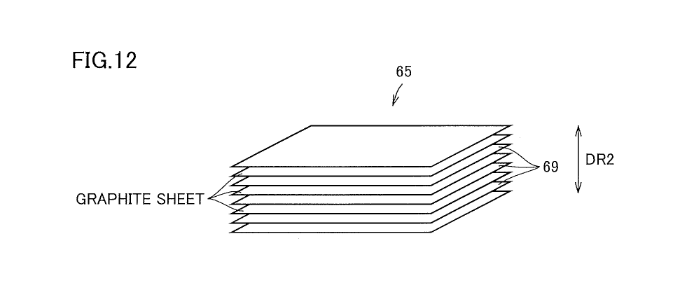

FIG. 12 is a schematic diagram of soaking member 65 according to a third embodiment. Unlike the first embodiment, soaking member 65 includes an adhesive layer 69 and a plurality of graphite sheets stacked in a thickness direction DR2 with adhesive layer 69 being interposed. Adhesive layer 69 contains an adhesive. Adhesive layer 69 is implemented, for example, by a double faced tape. Adhesive layer 69 bonds the graphite sheets to each other.

Soaking member 65 according to the third embodiment is desirably fabricated by stacking graphite sheets relatively small in thickness (specifically, a thickness not greater than 40 [μm]). Soaking member 65 according to the third embodiment is called a stack-type graphite sheet below. The stack-type graphite sheet is comparable in soaking effect to the graphite sheet according to the first embodiment (a single-layered graphite sheet below), with its thermal capacity being lower but with its thickness being the same.

A stack-type graphite sheet formed from two graphite sheets each having a thickness of 25 [μm] and adhesive layer 69 having a thickness of 5 [μm] has a thermal conductivity of 1600 [W/(m·K)]. Therefore, the stack-type graphite sheet is comparable to or higher than the single-layered graphite sheet (ζ=700 [W/(m·K)]) having a thickness of 100 [μm] in soaking effect.

Furthermore, since the stack-type graphite sheet is smaller in thickness, adoption of the stack-type graphite sheet is lower in thermal capacity than adoption of the single-layered graphite sheet. By adopting the stack-type graphite sheet, time required for temperature increase of fixation belt 61 can further be suppressed.

Specifically, ten seconds are required for temperature increase when a single-layered graphite sheet having a thickness of 100 [μm] is arranged, and 8.5 [seconds] are required for temperature increase when a stack-type graphite sheet (a thickness of 25 [μm]×two layers) is arranged.

### EXAMPLES

### Example 1

In Example 1, a test of various members for checking whether or not each member exhibited a soaking effect was conducted.

(Test Conditions)

The test was conducted in an environment at a temperature of 23 [° C.] and at a relative humidity of 65%. The fixation belt had an inner diameter of 30 [mm]. The fixation belt had a length in the axial direction of 340 [mm]. The rotational pressurization member had an outer diameter of 28 [mm]. The heat source had a length in the axial direction of 300 [mm]. A PTFE layer was adopted as the solid lubrication layer. The solid lubrication layer had a thickness of 60 [μm]. Stainless steel, aluminum, copper, and graphite were adopted as materials for the soaking member. The soaking member and the solid lubrication layer had an in-plane dimension in the fixation nip portion, of a short side of 10 [mm]×a long side of 320 [mm].

The soaking member made of graphite had a thermal conductivity of 1500 [W/(m·K)]. The soaking member made of copper had a thermal conductivity of 402 [W/(m·K)]. The soaking member made of aluminum had a thermal conductivity of 237 [W/(m·K)]. The soaking member made of iron had a thermal conductivity of 20 [W/(m·K)]. Each soaking member had a thickness of 200 [μm].

(Test Method)

A temperature of the heat source (heater) was adjusted such that a temperature at a central surface of the fixation belt attained to 150 [° C.] while the fixation belt was rotationally driven at a peripheral speed of 120 mm/s. Thereafter, sheets of paper having a size of A5T were fed for several minutes at a speed of 20 [sheets] per minute. After a temperature in the end region of the fixation belt became substantially constant, a highest temperature in the end region was measured. The temperature was measured with thermography.

(Test Results)

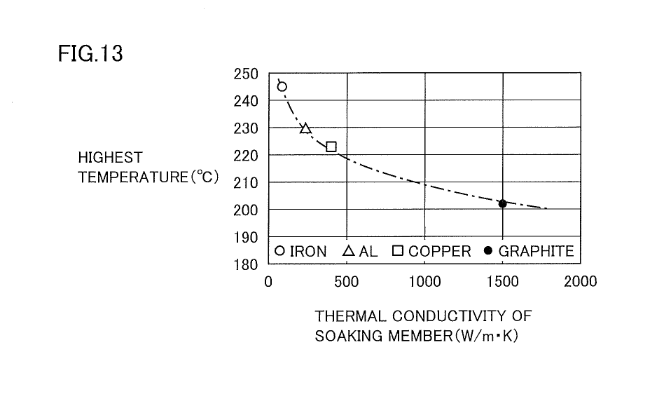

FIG. 13 shows a graph showing test results in Example 1. The highest temperature in the end region is lower as the soaking member is higher in thermal conductivity. Namely, it can be seen that the soaking effect is higher as the soaking member is higher in thermal conductivity.

The fixation belt is resistant to a temperature up to 230 [° C]. When a temperature exceeds 220° C. (a temperature with a margin of 10 [° C.] for the upper limit temperature of 230 [° C.]), a silicone rubber layer of the fixation belt starts to be hardened and the fixation belt may fail due to heat. Therefore, the fixation belt should practically be used at a temperature lower than 220 [° C.].

In order to ensure that the temperature of the fixation belt is lower than 220 [° C.], a temperature in the end region highest in temperature in the fixation belt should be lower than 220 [° C.]. It can be seen in the graph in FIG. 13 that, in order for the highest temperature in the end region to be lower than 220 [° C.], the soaking member should have thermal conductivity λ satisfying relation of λ≥500 [W/(m·K)].

As the soaking member has thermal conductivity λ satisfying relation of λ≥500 [W/(m·K)], the soaking function of the soaking member can be ensured and increase in temperature of the end region can be suppressed. Therefore, failure of the fixation belt can be suppressed.

### Example 2

In general, in an example where a member high in thermal conductivity is arranged in the fixation nip portion, as the member is higher in thermal capacity (greater in dimension such as a thickness), more time is required for temperature increase. In Example 2, a test of soaking members various in thickness for checking time required for temperature increase for each thickness was conducted.

(Test Conditions)

A graphite sheet was adopted as the soaking member. Graphite sheets of three patterns were tested. The graphite sheets had thicknesses of 100 [μm], 200 [μm], and 400 [μm], respectively. The graphite sheets having thicknesses of 200 [μm] and 400 [μm], respectively, were the stack-type graphite sheets in which graphite sheets each having a thickness of 100 [μm] were stacked. The graphite sheet having a thickness of 100 [μm] was a single-layered graphite sheet. Other test conditions were the same as in Example 1.

(Test Method)

While the fixation belt was rotationally driven at a peripheral speed of 120 [min/s], the heater was fully turned on from the off state, and time required for reaching a set fixation temperature (150 [° C.]) from a room temperature (23 [° C.]) (time required for temperature increase) was counted. Time required for temperature increase was counted for the graphite sheets having thicknesses of 100 [μm], 200 [μm], and 400 [μm], respectively.

(Test Results)

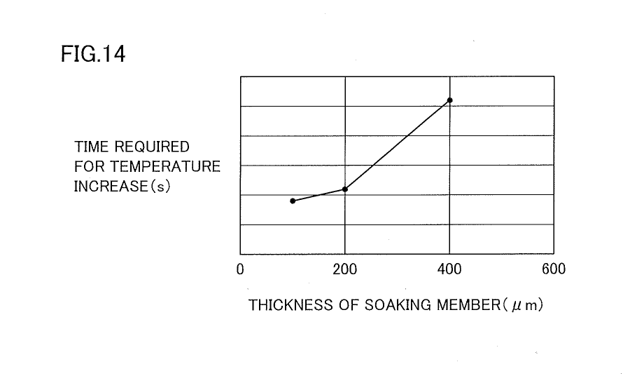

FIG. 14 shows a graph showing test results in Example 2. When a thickness of the graphite sheet exceeded 200 [μm], time required for temperature increase tended to abruptly increase. A similar experiment was conducted by adopting aluminum for the soaking member. Then, a tendency was similar to the experiment results of the graphite sheet. It can be seen in the experiment results that thickness t of the soaking member desirably satisfies relation of t≥200 [μm] in order to arrange a metal material for the soaking member in the fixation nip portion.

As thickness t of soaking member 65 satisfies relation of t≥200 [μm], time required for temperature increase of fixation belt 61 can be suppressed. Delay in start of printing can thus be suppressed.

### Example 3

In Example 3, various single-layered graphite sheets in which solid lubrication layers different in material and coefficient of linear theunal expansion were formed were fabricated. A test for checking relation between a coefficient of linear thermal expansion and a firing temperature of the solid lubrication layer and formation of wrinkles in the single-layered graphite sheets was conducted.

(Test Condition)

The single-layered graphite sheet had a two-dimensional dimension of a long side of 340 [mm]×a short side of 28 [mm]×a thickness of 100 [μm]. Various solid lubrication layers each having a thickness of 15 [μm] were fired on a surface of the single-layered graphite sheet.

Various fluorine resins (PTFE and PFA) were employed as the solid lubricant. The solid lubrication layer was fired by setting a firing temperature in accordance with each fluorine resin. Furthermore, various binder resins containing molybdenum disulfide as the solid lubricant were employed. The solid lubrication layer was fired by setting a firing temperature in accordance with each binder resin.

(Test Method)

After the solid lubrication layer was fired, the single-layered graphite sheet having the solid lubrication layer formed was attached as being centered to the pad member composed of a polyphenylene sulfide (PPS) material, by using a double faced tape. Since opposing surfaces of the pad member had a dimension of 340 [mm]×10 [mm], opposing sides of a short side of the single-layered graphite sheet extended off by 9 [mm] on each side. A surface of the single-layered graphite sheet having the solid lubrication layer formed and attached to the pad member was visually observed, and whether or not the surface was smooth was visually determined.

Evaluation as “A”, “B”, “C”, and “D” was made in the order of superiority. Absence of warpage and wrinkles was evaluated as “A”. Absence of wrinkles was evaluated as “B”. Slight formation of wrinkles (production at at most two locations within 340 [mm]) was evaluated as “C”. Formation of wrinkles (production at three or more locations within 340 [mm]) was evaluated as “D”.

(Test Results)

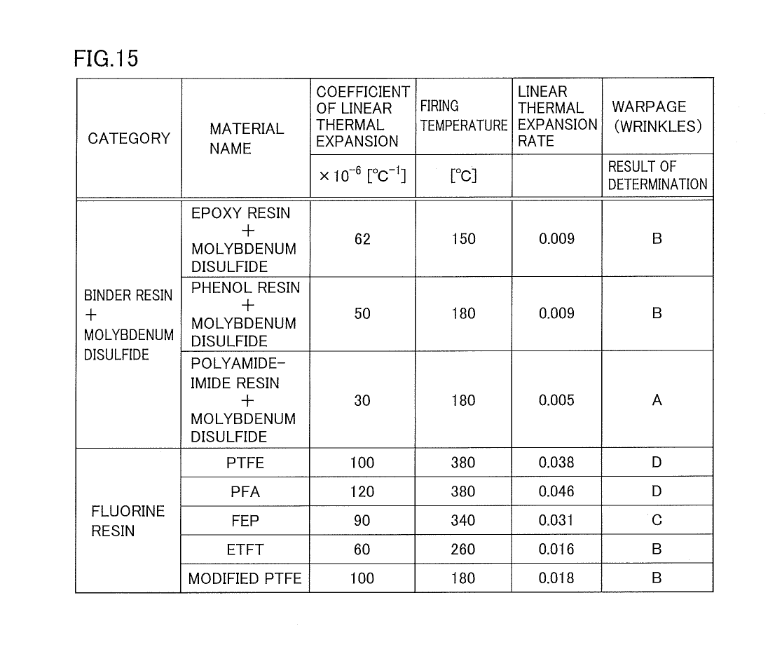

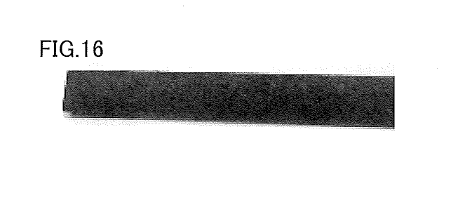

FIG. 15 shows a table showing test results in Example 3. FIG. 16 shows a photograph of the solid lubrication layer of which test results are evaluated as “D”. A value calculated as ∞×T is defined as a linear thermal expansion rate B [−] where α[° C.⁻¹] represents a coefficient of linear thermal expansion of the solid lubrication layer and T [° C.] represents a firing temperature of the solid lubrication layer. Based on the results in FIG. 15, when FEP was employed as the fluorine resin, linear thermal expansion rate B was 0.031 and slight wrinkles were formed (evaluation as “C”). It can be seen from this fact that relation of B<0.03 is preferably satisfied.

As linear thermal expansion rate B of solid lubrication layer 67 satisfies relation of B<0.03, curving of the graphite sheet in firing of solid lubrication layer 67 on the graphite sheet can be suppressed. Formation of wrinkles in the graphite sheet in arranging the graphite sheet on pad member 63 can thus be suppressed. Therefore, a shape of the fixation nip portion can be smoothened and good fixation quality can be ensured.

### Example 4

In a single-layered graphite sheet, there is a problem of curving of the single-layered graphite sheet due to a difference in coefficient of linear thermal expansion between the graphite sheet representing a soaking member and a solid lubrication layer formed on the graphite sheet.

In a stack-type graphite sheet, wrinkles may be formed due to a difference in coefficient of linear thermal expansion between the graphite sheet and an adhesive layer. This is because, in firing a PTFE layer (solid lubrication layer) on the stack-type graphite sheet, heating at 380 [° C.] is required and heat shrinkage of the adhesive layer occurs due to a temperature difference in returning from 380 [° C.] to a room temperature.

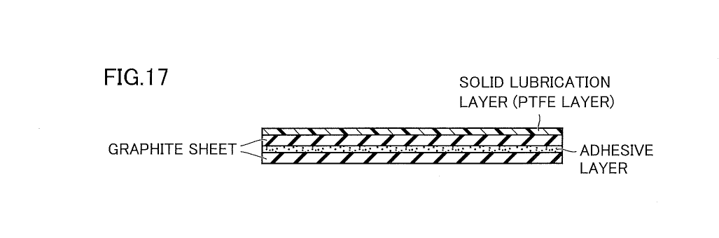

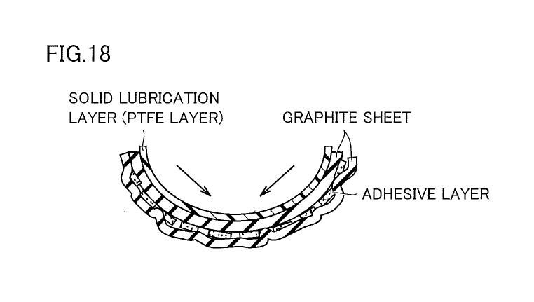

FIG. 17 is a schematic diagram of a stack-type graphite sheet when a PTFE layer is fired. FIG. 18 is a schematic diagram of the stack-type graphite sheet when the PTFE layer is fired and thereafter returns to a room temperature. The adhesive layer is higher in coefficient of linear thermal expansion than the graphite sheet. Therefore, when the PTFE layer is fired and thereafter it returns to the room temperature, the adhesive layer shrinks more than the graphite sheet.

When a firing temperature is too high in forming a coating on the stack-type graphite sheet, a surface of the stack-type graphite sheet deforms when a temperature returns to the room temperature after firing due to a difference in coefficient of linear thermal expansion between the graphite sheet and the adhesive layer.

When a firing temperature is low, in spite of a difference in coefficient of linear thermal expansion, a difference in amount of linear thermal expansion (=coefficient of linear thermal expansion×(firing temperature−room temperature)) is smaller and formation of wrinkles is less likely. In Example 4, a test for checking whether or not the stack-type graphite sheet deformed due to heating of the stack-type graphite sheet at various temperatures and thereafter leaving the stack-type graphite sheet was conducted.

(Test Conditions)

The graphite sheet which formed the stack-type graphite sheet had a thickness of 25 [μm]. The stack-type graphite sheet had a two-layered structure. A double faced tape was employed as the adhesive layer. The adhesive layer had a thickness of 5 [μm]. A base material for the double faced tape was acrylic.

(Test Method)

A constant temperature bath was set to various temperatures and the stack-type graphite sheet was left for two hours in the constant temperature bath. Thereafter, the stack-type graphite sheet returned to the room temperature. Whether or not a surface of the stack-type graphite sheet deformed was visually checked. Evaluation as “A”, “B”, and “C” was made in the order of superiority. Absence of deformation was evaluated as “A”. Minor deformation was evaluated as “B”. Defoiination was evaluated as “C”.

(Test Results)

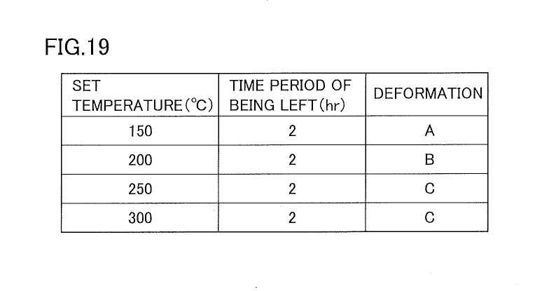

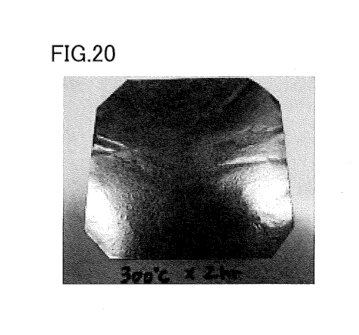

FIG. 19 shows a table showing test results in Example 4. FIG. 20 shows a photograph of the stack-type graphite sheet of which evaluation results are indicated as “C”. Minor deformation was observed when a temperature of the constant temperature bath was set to 200 [° C.]. It can thus be seen that a firing temperature in forming a solid lubrication layer desirably satisfies relation of T<180 [° C.].

As firing temperature T of solid lubrication layer 67 satisfies relation of T<180[° C], heat shrinkage of adhesive layer 69 can be suppressed. Curved deformation in firing of solid lubrication layer 67 on the stack-type graphite sheet can thus be suppressed.

Solid lubrication layer 67 may contain polyimide or epoxy as the binder. Curved deformation of soaking member 65 and solid lubrication layer 67 can thus be suppressed.

### Fourth Embodiment

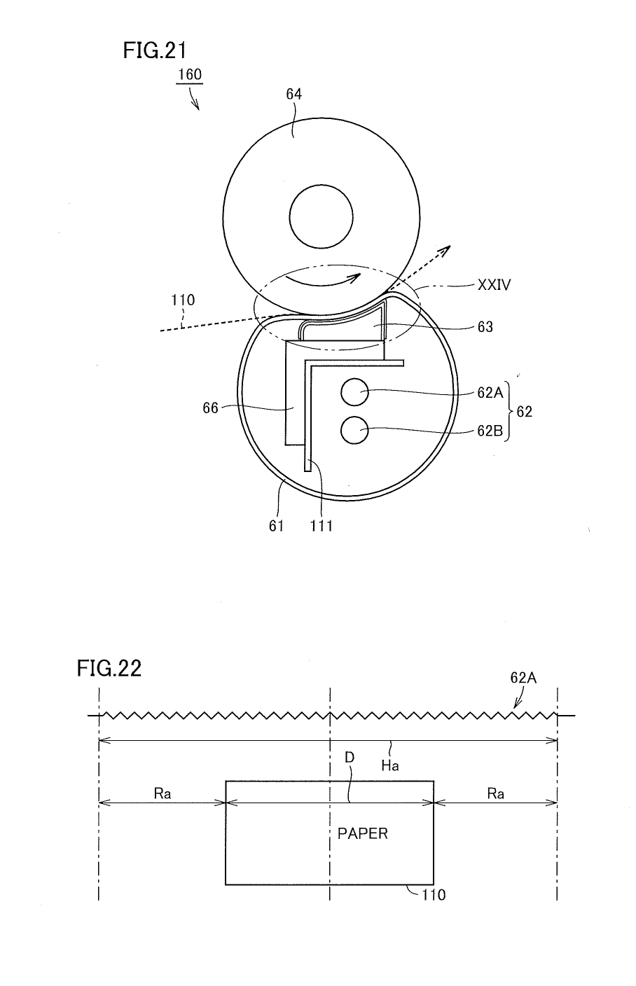

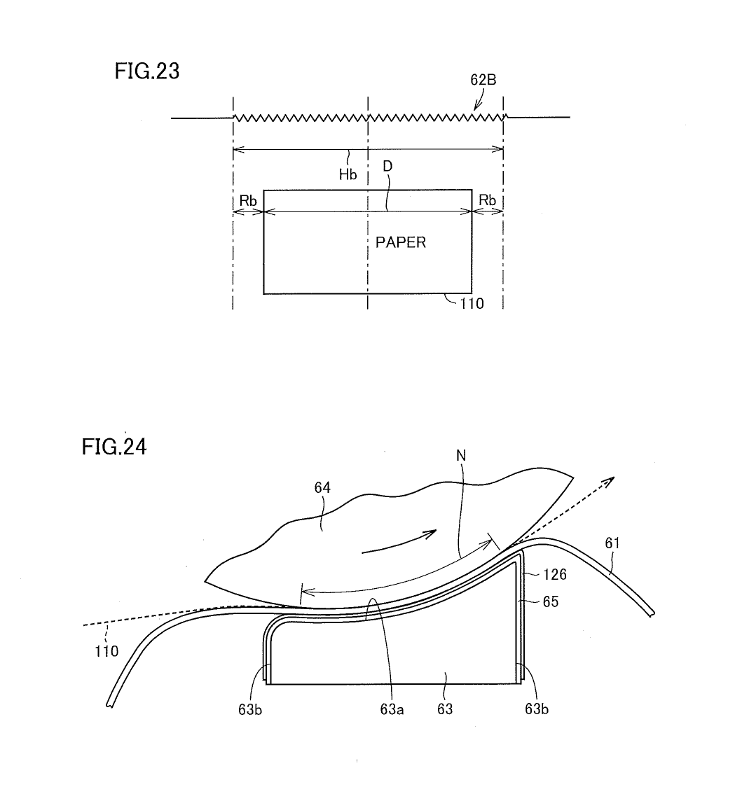

FIG. 21 is a side view showing a fixation apparatus in a fourth embodiment. FIG. 22 is a diagram schematically showing relation between a long heater in FIG. 21 and a size of paper. FIG. 23 is a diagram schematically showing relation between a short heater in FIG. 21 and a size of paper.

The fixation apparatus in the present embodiment is basically similar in structure to fixation apparatus 60 in the first embodiment. Description of a redundant structure will not be repeated below.

Referring to FIGS. 21 to 23, a fixation apparatus 160 in the present embodiment includes fixation belt 61, heat source 62, pad member 63, rotational pressurization member 64, support member 66, and a reflection member 111.

For example, a halogen heater is employed as heat source 62. Heat source 62 includes a long heater 62A and a short heater 62B. A length (heat source length) Ha of long heater 62A in the axial direction of rotational pressurization member 64 is longer than a length (heat source length) Hb of short heater 62B in the axial direction of rotational pressurization member 64. Heat source 62 is controlled such that long heater 62A generates heat in a step of fixation onto paper large in size and short heater 62B generates heat in a step of fixation onto paper small in size (for example, paper having an A5 size).

Reflection member 111 is attached to support member 66. Reflection member 111 is provided opposite to fixation belt 61 with respect to heat source 62. Reflection member 111 is constructed to reflect radiant heat from heat source 62.

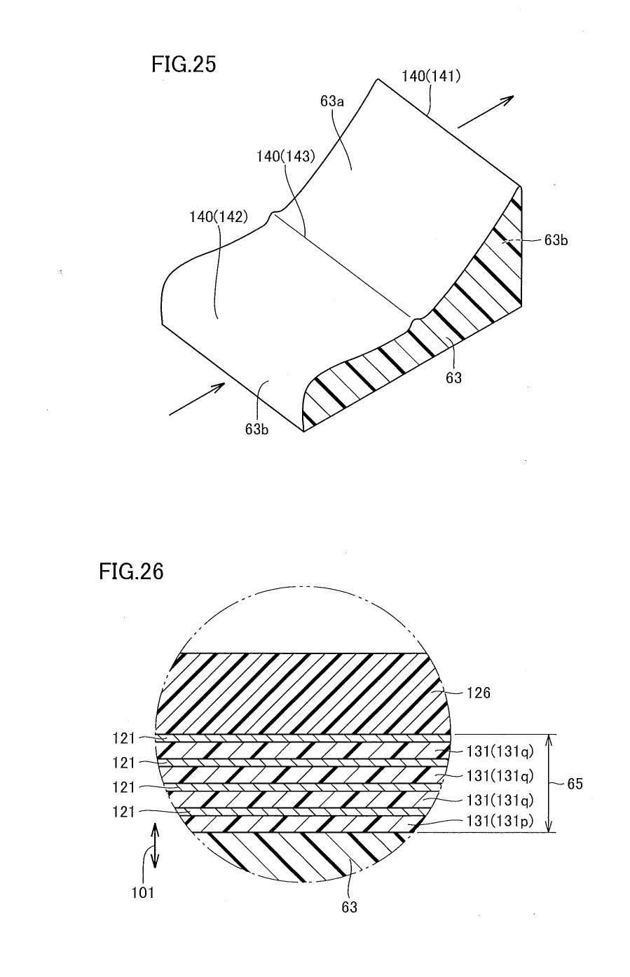

FIG. 24 is a side view showing the fixation apparatus in an area surrounded by a chain double dotted line XXIV in FIG. 21. FIG. 25 is a perspective view partially showing the pad member in FIG. 24. Referring to FIGS. 24 and 25, fixation nip portion N through which paper 110 passes is formed between fixation belt 61 and rotational pressurization member 64.

Pad member 63 is formed of a resin material. Pad member 63 is foimed, for example, of polyphenylene sulfide (PPS).

Pad member 63 includes opposing surface 63a and a pair of side surface portions 63b in its appearance. Opposing surface 63a is opposed to rotational pressurization member 64 in a direction of radius of an axis of rotation of rotational pressurization member 64. Opposing surface 63a extends as being curved along a circumferential direction around the axis of rotation of rotational pressurization member 64 (a direction of passage of paper 110). Opposing surface 63a is continuous to the pair of side surface portions 63b at opposing ends in the circumferential direction around the axis of rotation of rotational pressurization member 64.

Pad member 63 has a curved portion 140. A curvature of appearance of pad member 63 locally increases at curved portion 140.

More specifically, pad member 63 includes an upstream-side end portion 142, a downstream-side end portion 141, and a protruding portion 143 as curved portion 140.

Upstream-side end portion 142 and downstream-side end portion 141 are each implemented by a corner portion formed by opposing surface 63a and the pair of side surface portions 63b. Upstream-side end portion 142 is located on an upstream side in the direction of passage of paper 110 in fixation nip portion N. Upstream-side end portion 142 forms the corner portion together with side surface portion 63b as being opposed to rotational pressurization member 64. Downstream-side end portion 141 is located on a downstream side in the direction of passage of paper 110 in fixation nip portion N. Downstream-side end portion 141 forms the corner portion together with side surface portion 63b as being opposed to rotational pressurization member 64.

Downstream-side end portion 141 is greater in curvature than upstream-side end portion 142. According to such a construction, fixation belt 61 is more readily engaged in rotational pressurization member 64 in downstream-side end portion 141 and separability of paper 110 from fixation belt 61 can be enhanced.

Protruding portion 143 is provided as protruding from opposing surface 63a. Protruding portion 143 is in such a protruding shape as extending along a direction of the axis of rotation of rotational pressurization member 64. Protruding portion 143 is provided between upstream-side end portion 142 and downstream-side end portion 141 in the circumferential direction around the axis of rotation of rotational pressurization member 64. Protruding portion 143 is provided at a position coinciding with fixation nip portion N.

By providing protruding portion 143, a pressure applied to paper 110 in fixation nip portion N can locally be increased so that fixability of a toner image on paper 110 can be improved. Pad member 63 does not have to be provided with protruding portion 143.

Fixation apparatus 160 further includes soaking member 65 and a sliding layer 126. Soaking member 65 is provided between pad member 63 and fixation belt 61. Soaking member 65 is in a form of a sheet. Soaking member 65 is provided along a surface of pad member 63. Soaking member 65 is provided along curved portion 140 (upstream-side end portion 142, downstream-side end portion 141, and protruding portion 143).

Sliding layer 126 is provided between soaking member 65 and fixation belt 61. Sliding layer 126 is provided to lower friction force between soaking member 65 and fixation belt 61.

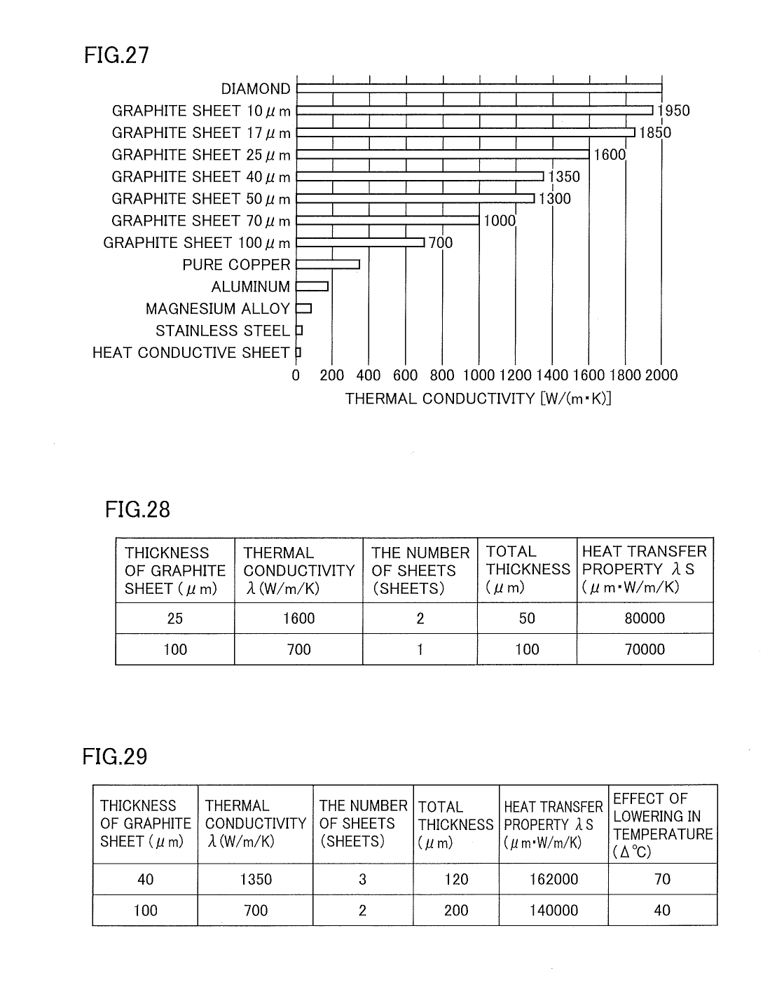

FIG. 26 is a cross-sectional view showing a surface layer of the pad member in FIG. 24 as being enlarged. FIG. 27 shows a graph of thermal conductivities of graphite sheets and various materials.

Referring to FIGS. 24 to 27, soaking member 65 includes a plurality of graphite sheets 121. The plurality of graphite sheets 121 are stacked on the surface of pad member 63 in a direction shown with an arrow 101 in FIG. 26 (a direction shown with arrow 101 in FIG. 26 will be referred to as a “direction of stack of graphite sheets 121” below).

Graphite sheet 121 is higher in thermal conductivity than aluminum or copper. Graphite sheet 121 has such a characteristic as being higher in thermal conductivity with decrease in thickness (sheet thickness) thereof.

As shown in FIGS. 22 and 23, in the present embodiment, long heater 62A and short heater 62B are used as being switched between a step of fixation onto paper large in size and a step of fixation onto paper small in size. Therefore, a width of end region R (which is the heated and non-paper-feed region) in the step of fixation onto paper 110 small in size (for example, an A5 size) can be suppressed (a width of an end region Rb<a width of an end region Ra).

In order to heat eritire paper 110, however, length Hb of short heater 62B should be greater than width D of paper 110. Therefore, fixation belt 61 is heated in end region R but is not cooled by paper 110, and hence a phenomenon of significant increase in temperature of fixation belt 61 may occur.

In contrast, in the present embodiment, soaking member 65 for soaking fixation belt 61 is formed of a stack of a plurality of graphite sheets 121. Since the graphite sheet has such a characteristic as being higher in thermal conductivity with decrease in thickness thereof, a high heat transfer property of soaking member 65 can be obtained while a thickness of soaking member 65 is suppressed.

By obtaining a high heat transfer property of soaking member 65, the effect of soaking of fixation belt 61 by soaking member 65 can be improved. With decrease in total thickness of soaking member 65, a thermal capacity of soaking member 65 is also lowered and time required for increase in temperature of fixation belt 61 (a time period required until a temperature of the fixation belt in the paper feed region reaches a fixation temperature) can be reduced.

FIG. 28 shows a table of comparison of a total thickness and a heat transfer property of soaking members, between a soaking member formed of a stack of graphite sheets and a soaking member formed of a single-layered graphite sheet.

As shown in FIG. 28, soaking member 65 formed of two graphite sheets 121 each having a thickness of 25 μm can be comparable to or higher than soaking member 65 formed of single graphite sheet 121 having a thickness of 100 μm in heat transfer property, although a total thickness of soaking member 65 is half.

The sheet composed of a graphite material is very brittle. Therefore, when the graphite sheet large in thickness is curved, a surface of the graphite sheet breaks at a position of curving and the heat transfer property may be impaired.

As shown in FIGS. 24 to 26, in the present embodiment, soaking member 65 is formed of a stack of a plurality of graphite sheets 121 so that a thickness of each graphite sheet 121 can be small. Thus, break of graphite sheet 121 can effectively be suppressed also in such a construction that soaking member 65 is provided along curved portion 140 of pad member 63 (upstream-side end portion 142, downstream-side end portion 141, and protruding portion 143).

When graphite sheet 121 has a maximum curvature not greater than 0.56 (l/mm), graphite sheet 121 has a thickness preferably not greater than 100 μm. According to such a construction, break of graphite sheet 121 can more reliably be suppressed.

Referring to FIGS. 24 to 26, soaking member 65 further includes an adhesive layer 131 (131p and 131q). Adhesive layer 131 is implemented, for example, by a heat resistant double faced tape.

Adhesive layer 131p is provided between pad member 63 and graphite sheet 121. Adhesive layer 131p is interposed between a surface of pad member 63 and graphite sheet 121 located in a lowermost layer in the direction of stack of graphite sheets 121. Adhesive layer 131q is provided between graphite sheets 121 adjacent to each other in the direction of stack.

According to such a construction, a gap (an air layer) between pad member 63 and graphite sheet 121 or between graphite sheets 121 adjacent to each other in the direction of stack can be prevented. The effect of soaking of fixation belt 61 by soaking member 65 can thus sufficiently be obtained.

When a double faced tape including a resin film as a base material is employed as adhesive layer 131, inward stress in a direction of stretching is applied to the resin film because the resin film goes through a stretching step during manufacturing thereof. Therefore, when the resin film is heated to a melting point (or a glass transition point Tg), the resin film may shrink. A thermal shrinkage of the resin film is varied depending on a stretching ratio and a condition for heat treatment in manufacturing of a resin film.

From such a point of view, adhesive layer 131 is preferably made of a single material. When a double faced tape is employed for adhesive layer 131, adhesive layer 131 is implemented preferably by a double faced tape of a type free from a base material.

Adhesive layer 131 is preferably silicone-based or acrylic. According to such a construction, adhesive force of adhesive layer 131 can be maintained high also in a high-temperature environment.

An acrylic adhesive is characterized by its excellent weatherability, heat resistance, and resistance to solvent. A silicone-based adhesive is characterized by a wide temperature region where it can be used because of its excellent cold resistance and heat resistance. Since silicone rubber itself is low in adhesiveness, a silicone resin is preferably used as a component which provides adhesiveness.

### Examples

### Example 5

FIG. 29 shows a table showing an effect of lowering in temperature of the fixation belt when a soaking member is formed of a stack of a plurality of graphite sheets in Example 5.

Referring to FIG. 29, in the present Example, a test for checking how an effect of lowering in temperature of the fixation belt is varied when a form of providing graphite sheet 121 in soaking member 65 is different was conducted.

A test directed to soaking member 65 in which three graphite sheets each having a dimension of 40 μm thick, 20 mm wide, and 350 mm long (having a thermal conductivity of 1350 W/m/K) were stacked, a test directed to soaking member 65 in which two graphite sheets each having a dimension of 100 μm thick, 20 mm wide, and 350 mm long (having a theinial conductivity of 700 W/m/K) were stacked, and a test as a comparative example without including soaking member 65 were conducted. When soaking member 65 was provided, an acrylic adhesive having a thickness of 8 μm was provided as adhesive layer 131.

In a fixation apparatus adapted to a direct heat system (fixing pad+fixation belt free system), a halogen heater having a length of 200 mm as heat source 62 was caused to emit light and paper was fed while the paper feed region was adjusted to 150° C. A condition for paper feed was set to a speed of 30 sheets of A6-sized paper per minute. Since a width of paper feed was set to 105 mm with respect to the length of 200 mm of the halogen heater, a width of end region R (the heated and non-paper feed region) was 47.5 mm on one side.

After successive feed of 150 sheets of paper under the paper feed condition above, a temperature of end region R of fixation belt 61 was measured with thermography and a highest temperature was recorded. In the comparative example without using soaking member 65, the highest temperature was 280° C.

When soaking member 65 in which three graphite sheets each having a thickness of 40 μm were stacked was employed, the highest temperature was 210° C. and an effect of lowering in temperature by 70° C. could be obtained. When soaking member 65 in which two graphite sheets each having a thickness of 100 μm were stacked was employed, the highest temperature was 240° C. and an effect of lowering in temperature by 40° C. could be obtained. It could be confirmed from these results that the effect of lowering in temperature of fixation belt 61 drastically improved by appropriately selecting a thickness of graphite sheet 121 and the number of stacked graphite sheets 121.

### Example 6

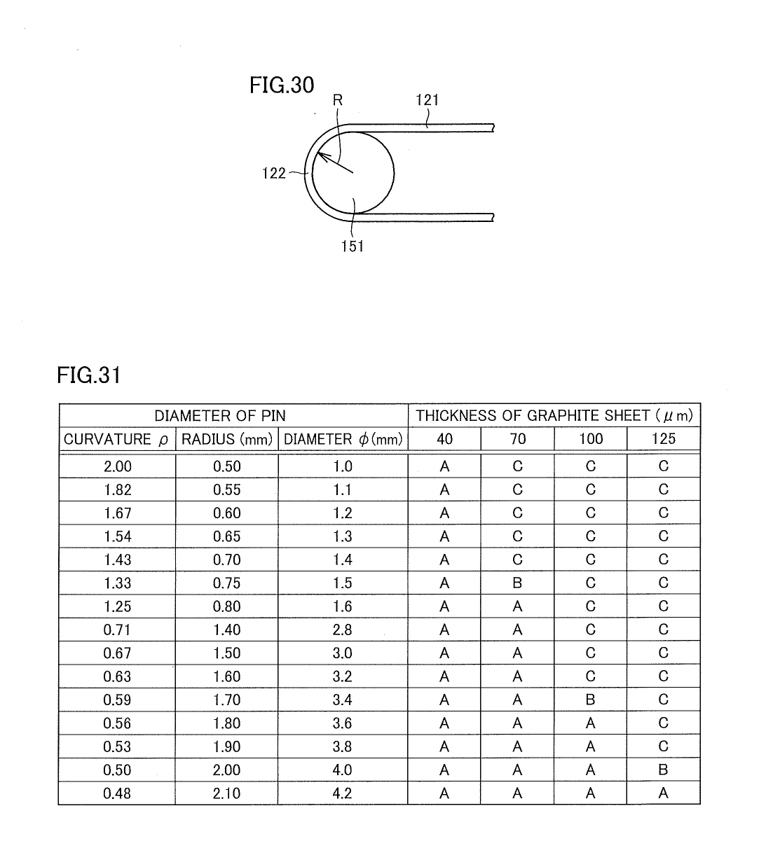

FIG. 30 is a diagram showing a manner of a graphite sheet winding test in Example 6. FIG. 31 shows a table showing results in the winding test in FIG. 30.

Referring to FIGS. 30 and 31, in the present Example, a plurality of types of pins 151 different in radius were prepared. A plurality of types of graphite sheets 121 different in thickness were wound around pins 151 such that the graphite sheet was folded back by 180°, and thereafter break in a folded-back portion 122 of graphite sheet 121 was visually observed.

In FIG. 31, an example in which no break in graphite sheet 121 was visually observed was evaluated as “A, an example in which a break was observed at one location was evaluated as “B”, and an example in which breaks were observed at a plurality of locations was evaluated as “C”. When graphite sheet 121 had a thickness not greater than 100 μm while graphite sheet 121 had a maximum curvature not greater than 0.56 (l/mm), break of graphite sheet 121 could more reliably be prevented.

Features of the fixation apparatus and the image formation apparatus in the embodiments descried above as well as functions and effects achieved by the fixation apparatus and the image formation apparatus are summarized below.

A fixation apparatus includes an endless fixation belt, a heat source which heats the fixation belt, a pad member arranged on an inner circumferential side of the fixation belt, a rotational pressurization member which presses the pad member with the fixation belt being interposed, and a soaking member provided between the pad member and the fixation belt. Thermal conductivity λ of the soaking member satisfies relation of λ≥500 [W/(m·K)].

According to the fixation apparatus, local increase in temperature of the fixation belt can be suppressed by ensuring an effect of soaking of the fixation belt by the soaking member.

In the fixation apparatus, thickness t of the soaking member satisfies relation of t≤200 [μm]. Time required for temperature increase of the fixation belt can thus be suppressed.

In the fixation apparatus, the soaking member contains graphite. An effect of soaking of the fixation belt by the soaking member can thus be ensured.

In the fixation apparatus, the soaking member includes a plurality of graphite sheets stacked in a direction of thickness thereof. Time required for temperature increase of the fixation belt can thus be suppressed while an effect of soaking of the fixation belt by the soaking member is ensured.

The fixation apparatus further includes a sliding layer provided between the soaking member and the fixation belt. A coefficient of friction of the sliding layer against the fixation belt is smaller than a coefficient of friction of the soaking member against the fixation belt. Drive torque of the fixation belt can thus be maintained low.

In the fixation apparatus, the sliding layer contains a solid lubricant. The fixation apparatus can thus be compact.

In the fixation apparatus, linear thermal expansion rate B [−] of the sliding layer calculated as α×T satisfies relation of B<0.03 where ∞[° C.⁻¹] represents a coefficient of linear thermal expansion of the sliding layer and T [° C.] represents a firing temperature of the sliding layer. Curved deformation of the soaking member in firing of the sliding layer in the soaking member can thus be suppressed.

In the fixation apparatus, the soaking member includes an adhesive layer and a plurality of graphite sheets stacked in a direction of thickness with the adhesive layer being interposed. The adhesive layer is greater in coefficient of linear thermal expansion than the graphite sheet. Firing temperature T of the sliding layer satisfies relation of T<180 [° C.]. Curved deformation of the graphite sheet can thus be suppressed.

In the fixation apparatus, the solid lubricant contains molybdenum disulfide. Curved deformation of the soaking member and the sliding layer can thus be suppressed.

In the fixation apparatus, the solid lubricant further contains a fluorine resin or graphite powders. Curved defoiination of the soaking member and the sliding layer can thus be suppressed.

In the fixation apparatus, the sliding layer contains polyimide, polyamide-imide, or epoxy as a binder which binds the solid lubricants to each other. Curved deformation of the soaking member and the sliding layer can thus be suppressed.

In the fixation apparatus, the soaking member includes a plurality of graphite sheets stacked on each other.

According to such a construction, the graphite sheet has such a characteristic as being higher in thermal conductivity with decrease in thickness thereof. Therefore, according to such a construction that the soaking member includes a plurality of graphite sheets stacked on each other, a high heat transfer property of the soaking member can be obtained while a thickness (thermal capacity) of the soaking member in the direction of stack of the graphite sheets is suppressed. Time required for temperature increase of the fixation belt can thus be suppressed and an effect of soaking of the fixation belt by the soaking member can be enhanced.

In the fixation apparatus, the pad member includes a curved portion where a curvature is locally great. The soaking member is provided along the curved portion.

According to such a construction, the soaking member in which a thickness of each graphite sheet is suppressed is provided along the curved portion of the pad member so that break of the graphite sheet can be prevented.

In the fixation apparatus, a fixation nip portion through which a recording medium passes is formed between the fixation belt and the rotational pressurization member. The pad member includes an upstream-side end portion which is located on an upstream side in a direction of passage of a recording medium in the fixation nip portion and defines a corner portion as being opposed to the rotational pressurization member and a downstream-side end portion which is located on a downstream side in the direction of passage of the recording medium in the fixation nip portion and defines a corner portion as being opposed to the rotational pressurization member. The soaking member is provided along at least any one of the upstream-side end portion and the downstream-side end portion.

According to such a construction, the soaking member in which a thickness of each graphite sheet is suppressed is provided along at least any one of the upstream-side end portion and the downstream-side end portion of the pad member so that break of the graphite sheet can be prevented.

In the fixation apparatus, when a maximum curvature of the graphite sheet is not greater than 0.56 (l/mm), the graphite sheet has a thickness not greater than 100 μm.

According to such a construction, break of the graphite sheet can more reliably be prevented.

In the fixation apparatus, the soaking member further includes an adhesive layer provided between the graphite sheets adjacent to each other in a direction of stack or between the graphite sheet and the pad member.

According to such a construction, an air layer which can be a heat insulating layer can be prevented from being produced between graphite sheets or between the graphite sheet and the pad member. The high effect of soaking of the fixation belt by the soaking member can thus be maintained.

What is claimed is:

1. A fixation apparatus comprising:
an endless fixation belt;
a heat source which heats the fixation belt;
a pad member arranged on an inner circumferential side of the fixation belt;
a rotational pressurization member which presses the pad member with the fixation belt being interposed; and
a soaking member provided between the pad member and the fixation belt,
a thermal conductivity λ of the soaking member satisfying relation of λ≥500 [W/(m·K)].

2. The fixation apparatus according to claim 1, wherein
a thickness t of the soaking member satisfies relation of t≤200 [μm].

3. The fixation apparatus according to claim 1, wherein
the soaking member contains graphite.

4. The fixation apparatus according to claim 3, wherein
the soaking member includes a plurality of graphite sheets stacked in a direction of thickness of the soaking member.

5. The fixation apparatus according to claim 1, the fixation apparatus further comprising a sliding layer provided between the soaking member and the fixation belt, wherein
a coefficient of friction of the sliding layer against the fixation belt is smaller than a coefficient of friction of the soaking member against the fixation belt.

6. The fixation apparatus according to claim 5, wherein
the sliding layer contains a solid lubricant.

7. The fixation apparatus according to claim 6, wherein
a linear thermal expansion rate B [−] of the sliding layer calculated as axT satisfies relation of B<0.03 where α[° C.⁻¹] represents a coefficient of linear thermal expansion of the sliding layer and T [° C.] represents a firing temperature of the sliding layer.

8. The fixation apparatus according to claim 6, wherein
the soaking member includes an adhesive layer and a plurality of graphite sheets stacked in a direction of thickness with the adhesive layer being interposed,
the adhesive layer is greater in coefficient of linear thermal expansion than the graphite sheet, and
a firing temperature T of the sliding layer satisfies relation of T<180 [° C.].

9. The fixation apparatus according to claim 6, wherein
the solid lubricant contains molybdenum disulfide.

10. The fixation apparatus according to claim 9, wherein
the solid lubricant further contains a fluorine resin or graphite powders.

11. The fixation apparatus according to claim 9, wherein
the sliding layer contains polyimide, polyamide-imide, or epoxy as a binder which binds solid lubricants to each other.

12. The fixation apparatus according to claim 1, wherein
the soaking member includes a plurality of stacked graphite sheets.

13. The fixation apparatus according to claim 12, wherein
the pad member includes a curved portion where a curvature is locally great, and the soaking member is provided along the curved portion.

14. The fixation apparatus according to claim 12, wherein
a fixation nip portion through which a recording medium passes is formed between the fixation belt and the rotational pressurization member,
the pad member includes
an upstream-side end portion which is located on an upstream side in a direction of passage of the recording medium in the fixation nip portion and defines a corner portion as being opposed to the rotational pressurization member, and
a downstream-side end portion which is located on a downstream side in the direction of passage of the recording medium in the fixation nip portion and defines a corner portion as being opposed to the rotational pressurization member, and
the soaking member is provided along at least any one of the upstream-side end portion and the downstream-side end portion.

15. The fixation apparatus according to claim 12, wherein
when a maximum curvature of the graphite sheet is not greater than 0.56 (l/mm), the graphite sheet has a thickness not greater than 100 μm.

16. The fixation apparatus according to claim 12, wherein
the soaking member further includes an adhesive layer provided between the graphite sheets adjacent to each other in a direction of stack or between the graphite sheet and the pad member.

17. The fixation apparatus according to claim 16, wherein
the adhesive layer is composed of a single material.

18. The fixation apparatus according to claim 16, wherein
the adhesive layer is silicone-based or acrylic.

19. An image formation apparatus comprising:
a transport portion which transports a recording medium; and
the fixation apparatus according to claim 1, the fixation apparatus fixing a toner image onto the recording medium.
